(19) United States
(12) Patent Application Publication
(10) Pub. No.: US 2012/0147191 A1
(43) Pub. Date: Jun. 14, 2012

(54) SYSTEM AND METHOD FOR LOCATING A TARGET WITH A NETWORK OF CAMERAS

(75) Inventor: Hichem Snoussi, St Andre Les Vergers (FR)

(73) Assignee: UNIVERSITE DE TECHNOLOGIE DE TROYES, Troyes Cedex (FR)

(21) Appl. No.: 13/264,711

(22) PCT Filed: Apr. 19, 2010
(86) PCT No.: PCT/FR2010/050751

§ 371 Date: Mar. 2, 2012

(30) Foreign Application Priority Data
Apr. 17, 2009 (FR) 09/01880
Oct. 2, 2009 (FR) 09/04714

(51) Int. Cl. G06K 9/00; H04N 7/18

(52) U.S. Cl. 348/159; 382/103; 348/143; 348/E07.085

(57) ABSTRACT

The present invention relates to a system, a method and an intelligent camera for following at least one target (X) with at least one intelligent camera (S) comprising means (S1) for processing data implementing at least one algorithm (AS, AD, AF) for following target(s), means (S2) for acquiring images and means (S21) for communication, characterized in that a detection of at least one target (X) in the region (Z) covered, by virtue of at least one algorithm (AD) for detection at an initial instant, is followed, for each instant (t), by an iteration of at least one step of following the target (X) with at least one camera, termed an active camera, by virtue of at least one variational filtering algorithm (AF) based on a variational filter by estimation (551) of the position of the target (X) through a continuous mixture of Gaussians.

The present invention relates to the field of electronics, particularly to networks of image sensors such as cameras, and particularly to the field of locating and/or tracking a target or targets using a network of so-called “intelligent” cameras. The present invention relates more particularly to a system and a method for locating over time, that is for tracking, a target using a network of intelligent cameras.

The image capture devices used in the present invention are hereinafter called “cameras” for the sake of simplicity and with reference to the fact that when it is desired to acquire sequences of images (video) with a camera, it is obvious that it is also possible to simply acquire static images. The invention proposes a network of cameras to allow the location of a target (an object or a person, by way of non-limiting examples). In fact, the term “camera” (or “intelligent camera”) designates, in the present application, devices including image (static or video) acquisition means, means of processing data, particularly data representative of such images, and communication means for transmitting information relating to such processing to one another and/or to a higher-level system or to a human. The present application refers to wireless communication, but it should be obvious that it is possible to use wired communication even though it is more practical to use wireless communication, particularly as the present invention makes it possible to minimize the quantity of information passing over these communication means and therefore does not require the higher transfer rates provided by wired communication compared with wireless communication.

A wireless camera network (WCN) is generally a system consisting of several tens to several hundred interconnected nodes (or “intelligent cameras” as defined above). These nodes each consist of a camera (or image acquisition means), an information processing unit and communication means. The nodes have a restricted coverage area and are deployed in heterogeneous environments. They are autonomous, and have for that purpose a store of energy, the replenishment whereof can prove impossible, which limits their lifetime. It is therefore useful to minimize the cost of each node. Each node must be capable of processing the data received, of making a local decision and of communicating it independently to neighboring nodes to which it is connected. This cooperation is intended in ensure the best decision-making possible despite limitations in terms of power consumption and of processing power. WCNs are therefore subject to strong constraints of multiple types, energetic and computational among others, which limits the processing and communications capabilities of the nodes in the network. Nevertheless, they must satisfy strict objectives in terms of service quality considering the sensitive nature of the systems on which they are intended to be deployed. In this context, it is paramount that the solutions proposed be cooperative and call on distributed intelligent techniques, as regards both the communication mode and the real-time processing of the images acquired. The wireless aspect of communication can be exploited within the scope of sensor networks for transmitting information and must consequently be taken into account in designing the signal processing algorithms. Conversely, these algorithms rely on communication between the units and impose strong constraints on communication.

Real-time video surveillance has attracted particular interest of the highest order within the scientific and industrial communities for the last several years. Several projects have been carried out in tracking moving persons or objects from a single camera. Numerous solutions are known for detecting a target, for example by shape recognition or some other method, and no details will be given here regarding detection algorithms. Despite the complexity of the algorithms and models proposed, tracking with a single camera is complicated by the presence of obstacles of various types within the scene considered. In particular, sophisticated treatments based on appearance models or on the principle of the color correlogram have been suggested in order to avoid the problem of partial or complete obstacles. Other methods of Bayesian probabilistic filtering based on a priori models of motion are known. However, the incorporation of an a priori dynamic model of the target does not offer sufficient reliability with respect to the obstacles encountered (static obstacles or mixture of persons in motion). The use of several cameras having different views of the monitored scene seems to provide a reliable solution with respect to the presence of obstacles. Different data fusion strategies have been proposed in the literature in order to exploit the video streams emanating from distributed cameras. A first class of commonly used strategies consists of detecting the target with each camera and calculating mappings between cameras based on their calibrations and on the principal axes of the objects being tracked. The principal defect of this kind of method is the need for all targets to be detected and correctly tracked. The other defect is the fact that all cameras must be active simultaneously, which is not possible in the context of a network of cameras that are wireless and autonomous and have a limited and non-renewable store of energy. The second class of methods is based on particle filtering for fusing the data from the different cameras. Particle filtering consists of a approximating the probability density of the system state (knowing all video images up to the current instant) using a sequential Monte Carlo method. The entire advantage of this approach is its ability to resolve the nonlinear dynamic model without recourse to analytical approximations. The nonlinear aspect arises mainly from the video observation model which is strongly nonlinear.

Two types of methods are distinguished within this category:

1. 3D particle filtering: This involves simulating a very large number of particles (system states such as position, speed, direction, . . . ) according to an instrumental probability distribution in 3D space, projecting these particles in the plane of each camera to calculate its likelihoodlevel in that same camera and finally multiplying the likelihood levels of all the selected cameras to fuse the data. The defect in this strategy is its centralized nature which requires the transmission of video streams to a central unit. This centralized aspect is not acceptable within the scope of a wireless camera network due to energy limitations and also for reasons of security, as the deterioration of the central unit disables the operation of the entire surveillance system.

2. Collaborative particle filtering: This approach consists of combining several particle filters implemented in the different cameras. This combination relies on exchanges of messages in order to attain the same performance as the centralized particle filter. Though it is distributed, this method requires a considerable exchange of messages leading to a high communication cost. In addition, this method does not include resources for selecting a subset of cameras capable of attaining the same tracking performance as the network as a whole.

Comparing the 2 classes of method described above, it can be noted that Bayesian filtering implemented with the particle approach offers a more robust probabilistic framework for tracking targets within a network of cameras. However, the particle approach cannot accommodate the energy constraints within the context of a network of autonomous cameras. Thus, prior art solutions have major disadvantages for the deployment of low cost networks of autonomous cameras.

In addition, embedded networks of wireless cameras are known from prior art which have the advantages of decentralized processing of acquired images in the cameras (as previously defined, incorporating processing means), with high resolution (for example, a 3.1 megapixel CMOS sensor) allowing images to be obtained that are 30 times more precise than those obtained with analog technology and with camera fields of vision of up to 360 degrees, thus minimizing the number of cameras needed for the surveillance of larger areas.

However, this type of solution has the disadvantages of cost (particularly for motorizing the cameras), of decentralized processing which is limited to the local processing of the image for better visibility, of the absence of collaborative processing, resulting in system failure under difficult conditions such as the presence of several obstacles, of a network concept which is limited to the use of several cameras to have several views of the same scene, without intelligent distributed processing and with too great a camera size, posing a risk of damage by intruders instead of allowing discrete and effective surveillance.

One major problem in the field of intelligent camera networks relates therefore to collaborative processing carried out by these cameras. There is a considerable need for cameras which allow effective collaborative processing requiring limited resources and particularly for a network of cameras allowing several cameras to simultaneously carry out tracking of at least one target thanks to mutual collaboration.

In this context, it is worthwhile to propose a network of cameras for locating (and/or tracking) of target proposing more advanced processing such as detection, tracking of moving objects, decision-making, thanks to collaborative processing of images, while minimizing the exchange of information thanks to intelligent cameras exchanging information resulting from local processing in order to satisfy an estimation and decisions goal, within a network as that term is understood in the telecommunication sense, supporting several architectures such as for example broadcast, peer-to-peer, etc.

The present invention has as its object to propose a process for locating a target using a network of cameras that makes it possible to palliate at least some disadvantages of the prior art.

This goal is attained by a method for tracking at least one target using a network of intelligent cameras comprising data processing means implementing at least one target tracking algorithm, image acquisition resources and communication resources, the camera network covering at least one geographical area, called a region, characterized in that it comprises detection of at least one target within the region, by at least one camera in the network, thanks to at least one detection algorithm, then, for each instant, an iteration of at least one target tracking operation by at least one camera called the active camera, thanks to at least one variational filtering algorithm using a model, called a transition model, relying on a temporal correlation of a trajectory of the target from one instant to another, employing an estimate of the target's position.

In particularly advantageous fashion, the tracking method uses a likelihood function of the target position within the image acquired by said active camera, and the transition model is represented by a continuous mixture of Gaussians allowing estimation of the position of the target by a probability density.

According to another special feature, the tracking, at a given instant, also comprises a determination of data representative of a sufficient statistic in temporal terms, representing knowledge of the trajectory, to continue the tracking of the target in the following instant.

According to another special feature, the tracking, at a given instant, also comprises a determination of a relevance indicator of the estimate of the target position, thanks to at least one selection algorithm allowing selection of at least one active camera for performing tracking according to its relevance indicator, which represents the difference between the probability density of the predicted target position in the previous instant and the probability density of the estimated target position in the current instant.

According to another special feature, the detection of at least one target present in the region, at an initial instant, triggers the tracking of the target by all the cameras having detected the target, followed by a competition between cameras according to the relevance indicator determined, for selecting the most relevant and assembling a set of cameras, called the active set, assigned to the tracking task at the given instant.

According to another special feature, the determination of a relevance indicator in the processing performed triggers a comparison of the relevance indicator, for each camera active at a given instant, with a threshold determined in the selection algorithm allowing the camera, depending on the result of this comparison, to continue tracking or to give it up.

According to another special feature, the comparison, for each camera active at a given instant, of its relevance indicator with a threshold, is accompanied by a comparison of the change in the relevance indicators of the other cameras so as to take this change into account in deciding between continuation and termination of tracking, and deciding whether or not to transmit to the other cameras in the network its data representing the sufficient statistic determined by this camera, this transmission triggering a reiteration of the competition between the cameras to form a new set when the relevance indicator of all the cameras crosses the threshold.

According to another special feature, the tracking step comprises, at every instant, an iteration of a prediction of the position(s) of the target(s) in the following instant.

According to another special feature, the data representing the sufficient statistics in temporal terms are representative of a mean and a covariance of the random mean of the estimated position of the target.

According to another special feature, the cameras have known geographic localities thanks to the fact that their processing resources use data representing relative positioning of their respective fields of vision.

According to another special feature, the tracking step, by variational filtering, at a given instant, when several cameras are activated, is implemented in collaborative fashion by the active cameras, thanks to dependencies between their respective variational filters expressed by a dynamic homography model connecting the random means of the target position respectively estimated by each of the active cameras.

According to another special feature, tracking is carried out collaboratively by the active cameras by exchanging data representative of sufficient statistics in spatial terms between cameras, in addition to those in temporal terms, these sufficient statistics in spatial terms representing the expected positions of the target in the image of each active camera at the current instant.

The present invention also has the object of proposing a system for target location by a network of sensors allowing at least some drawbacks of the prior art to be palliated.

This object is attained by a system for the tracking of at least one target by a network of intelligent cameras, each comprising data processing resources, image acquisition resources and communication resources, the camera network covering at least one geographic area, called the region, characterized in that the data processing resources implement at least one algorithm for locating and tracking a target or targets by implementing the method according to the invention.

According to another special feature, at least one algorithm used is based on a variational filter allowing the data exchanged between cameras for tracking to be limited to one mean and one covariance.

According to another special feature, at least one image is acquired during tracking by at least one of the cameras, selected according to its position with respect to the coordinates and/or the trajectory of the target.

According to another special feature, said image, acquired by at least one camera selected according to its position, is stored in the memory resources of the same camera.

According to another special feature, the system comprises at least one centralization device comprising resources of communicating with the cameras in the system and storage and/or display resources for respectively storing and/or displaying data relating to tracking and/or to said acquired image, transmitted by the cameras.

According to another special feature, the centralization device comprises data entry resources allowing an operator to check the tracking of the target based on data transmitted by the cameras and displayed on said device and, if applicable, to alert a cognizant office via the communication resources of said device.

Another aim of the present invention is to propose a device for target location by a sensor network allowing palliating at least some drawbacks of the prior art. Such a device allows implementation of the invention, alone or in cooperation with other devices of the same type.

This aim is attained by an intelligent camera covering at least one geographic area and comprising data processing resources, image acquisition resources, characterized in that the data processing resources implement at least one algorithm for locating a target or targets by implementing the method according to at least one embodiment of the invention where a single camera can carry out tracking.

According to another special feature, the intelligent camera includes communication resources for communicating with another intelligent camera for implementing the method according to at least one embodiment of the invention where several cameras can perform tracking in succession or in collaboration.

According to another special feature, the intelligent camera includes communication resources for communicating with a centralization device having resources of communicating with at least one camera and storage and/or display resources for respectively storing and/or displaying data relating to tracking and/or to said acquired image.

Other special features and advantages of the present invention will appear upon reading the following description, made with reference to the appended drawings, in which:

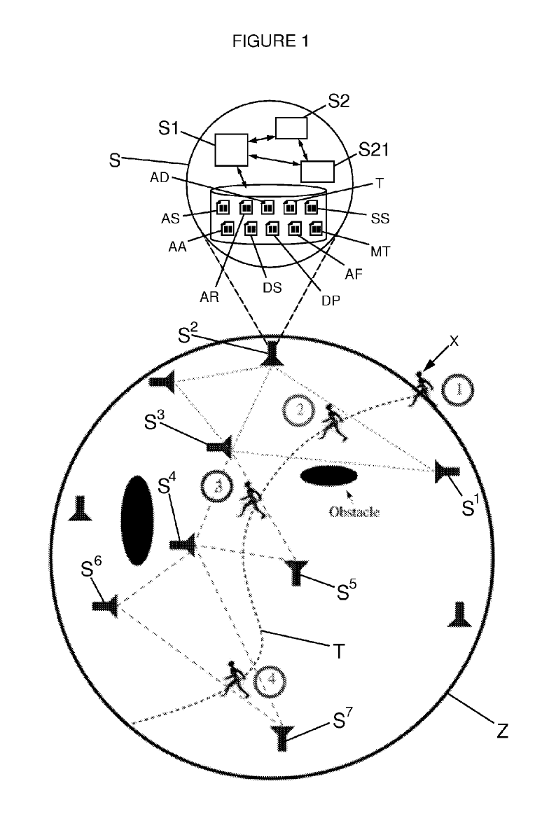

FIG. 1 shows an embodiment of the tracking system according to the invention tracking a target over time, with a magnified view of one sensor in the network,

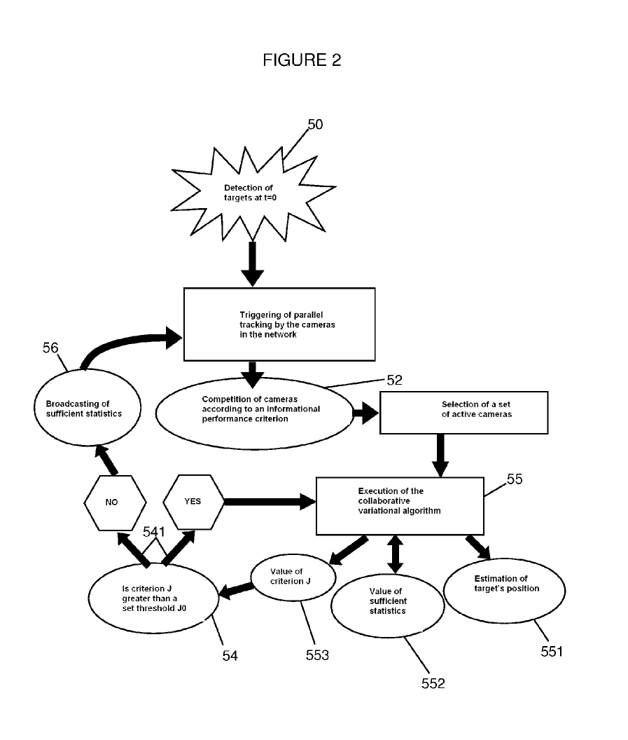

FIG. 2 shows an embodiment of the location process according to the invention,

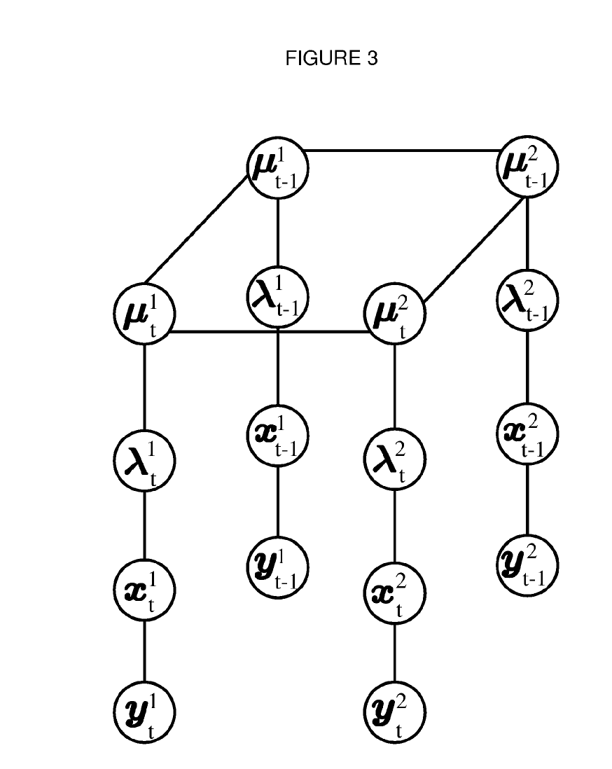

FIG. 3 shows a model of a dynamic state in the case of 2 cameras simultaneously implementing the variational filter.

The present invention relates to a system and a method for the tracking of at least one target by a network of intelligent cameras as defined previously. These intelligent cameras(S) have known geographic locations and each include data processing resources (S1) implementing at least one algorithm (AS, AD, AF) for tracking a target or targets, image acquisition resources (S2) and communication resources (S21). The network of cameras (S) also makes it possible to cover at least one geographic area, called the region (Z), wherein the collaborative processing carried out by the camera network allow effective surveillance at low cost, particularly with cameras having limited computation resources and power. The communication resources can be wired or wireless. Preferably, the invention will be implemented in a network of autonomous cameras (i.e. not requiring a higher level system) which implement the invention in collaborative fashion. The processing resources can be reconfigurable according to changes in the camera population.

The method comprises detection (50) of at least one target (X) in the region (Z), by at least one camera (S) in the network, using at least one detection algorithm (AD), followed, for each instant (t), by an iteration of at least one tracking operation (55) of the target (X) by at least one camera, called the active camera, using at least one variational filtering algorithm (AF) based on a variational filter, by estimation (551) of the position of the target (X) by a probability density. The system comprises the networked cameras and the data processing resources (S1) implement at least one algorithm (AS, AD, AF) for locating a target or targets by implementing the method according to the invention. FIG. 1 shows an example of implementation of such a system.

FIG. 2 shows an example of implementation of the method. In this embodiment, the detection (50) of at least one target (X) present in the region (Z) at an initial instant, triggers the tracking operation (55) of the target by all the cameras having detected the target (X), that is the estimate of the target's position. In certain embodiments, following this initial instant where all the cameras having detected the target are carrying out tracking, a selection of active cameras (which will continue the tracking) is carried out using the calculation of a relevance indicator (J) representing the relevance of the estimate of the target's position performed by each camera. Thus, in certain embodiments, the method continues with a competition (52) between cameras, based on the determined relevance indicator (J), to select and assemble a set (I) of cameras, called active cameras, assigned to the tracking task (55) at the given instant (t). The tracking operation (55) at a given instant (t) generally also comprises a determination (552) of data (SS) representative of a sufficient statistic of the target (X) at the following instant (t+1). In certain embodiments, the computation of the relevance indicator (J) takes place at each instant. In this case, the tracking operation (55) at a given instant (t) also comprises a determination (553) of a relevance indicator (J) of the processing performed, using at least one selection algorithm (AS) allowing selection of the cameras that will continue the tracking (and those that will drop the tracking). In certain embodiments, the determination (553) of a relevance indicator (J) of the processing performed (estimate performed) triggers a comparison (54), for each camera active at the given instant (t), of the relevance indicator (J) with a threshold determined in the selection algorithm (AS) allowing the camera, depending on the result of this comparison, to continue tracking (55) or to give it up by transmitting (56) to the other cameras in the network data (SS) representative of the sufficient statistic in temporal terms determined by that camera. The comparison (54), by each camera active at a given instant (t), of its relevance indicator (J) with a threshold is, in certain embodiments, accompanied by a step consisting of comparison (541) of the change in the relevance indicators (J) of the other cameras, to take this change into account in the decision between continuing tracking (55) and giving it up. For example, when the relevance indicator (J) of an active camera drops below a threshold while that of other cameras remains above the threshold, the camera gives up the tracking of a target without triggering an alert in the network. On the other hand, when the criterion (J) decreases for all active cameras, an alert is broadcast in the network in order to assemble a new set of relevant cameras. Thus, when the comparison (541) of the change in the indicators (J) of the other cameras results in the fact that the indicator is decreasing for several cameras, the transmission (56) of the data (SS) representative of the sufficient statistic in temporal terms is accompanied by a reiteration of the competition (52) between cameras to form a new active set. When this set is assembled, the cameras that were active give up tracking and hand over so that other cameras more able to follow the target activate and perform the tracking. In the contrary case, if no camera is able to have a relevance indicator (J) greater than the threshold, the cameras do not give up tracking. The competition (52) launched when the comparison (541) of the change in the indicators (J) determined that all the indicators (J) are decreasing therefore takes into account the indicators (J) of all the cameras (the active cameras liable to be deactivated and the inactive cameras liable to be activated), so as to maintain the most relevant cameras.

In certain embodiments, the tracking operation (55) comprises, at every instant (t), an iteration of a prediction of the position(s) of the target(s) at the following instant. This prediction is allowed by an estimate of the trajectory (T) of the target (X). As detailed hereafter, the estimation (551) using the variational filtering algorithm (AF), relies on the use of a model (MT), called the transition model, relying in particular on a temporal correlation of an assumed trajectory (T) of the target (X) from one instant to another. An expression of this transition model (MT) by a continuous mixture of Gaussians is detailed hereafter and allows definition of the predicted (estimated) position of the target (X) by a probability density. The values assumed by the means of the probability densities representing the successive positions of the target allow the definition of a trajectory (T) of the target (X). In particularly advantageous fashion, the variational filtering algorithm allows the data (SS) representative of the sufficient statistics in temporal terms to be representative of a mean and a covariance of the estimated position of the target (X). The present invention advantageously allows data transmission between cameras to be limited to these sufficient statistics in temporal terms. This position prediction for the target can therefore include at least one step consisting of determining (552) the sufficient statistic in temporal terms to allow continuation of tracking. Thus, the cameras can, at least in the case where one camera at a time performs tracking at a given time (t), transmit to one another only the data representative of this temporally relevant information so as to economize data transmission and hence power consumed.

In the case of several cameras activated at the same time to carry out collaborative filtering, the tracking operation (55) by variational filtering, at the instant (t), is implemented collaboratively by exchanging data (SS) representative of sufficient statistics in spatial terms between cameras, in addition to those in temporal terms. Indeed, in the case of several cameras activated at the same time, they will also be able to exchange date representative of sufficient statistics in spatial terms, such as the distribution of a position xₜ^{s} of the target (X) in the image yₜ^{s} emanating from each camera (S) collaborating at a given instant (t), as explained hereafter.

FIG. 2 illustrates the following sequence, representative of certain embodiments of the method:

1. Detection/classification (50) of objects to be followed (target X) at instant t=0.
2. Triggering of tracking (55) by cameras having detected the target.
3. Competition (52) between the cameras of the set according to the indicator (J) detailed hereafter (informational criterion) for selecting a reduced set Iₜ of cameras assigned to tracking the target.
4. Tracking (55) of the target by execution of the collaborative variational algorithm (AF), with:

(a) Estimation (551) of the position of the target (X) with a likelihood interval.

(b) Determination (552) of at least one sufficient statistic (SS) for continuing tracking at the following instant.

(c) Determination (553) of a relevance indicator (J) of the processing performed.

5. Comparison (54): If the calculated indicator of the previous step is greater than a set threshold, the camera continues tracking; otherwise, two cases can occur:

a) The indicators of all the active cameras drop below the set threshold. An alert is broadcast in the network to assemble a new set of active cameras. If this set is assembled, the sufficient statistic is communicated and the method returns to tracking (points 2 and 3 above) to put the cameras back into competition.

b) At least one camera of the active set has an indicator above the threshold. The camera(s) the indicator whereof has dropped below the threshold then give(s) up tracking without triggering an alert.

The present invention therefore proposes, in a preferred embodiment, a decentralized and cooperative system for the detection/classification of intrusion and for tracking moving objects using a network of autonomous, miniature, wireless cameras. This distributed mode has the advantage of being particularly resistant to outside attack and to camera failure because it is designed so that the loss of a component does not compromise the effectiveness of the network as a whole. The technique proposed is based on a variational approach accommodating communication constraints in terms of data transfer rate and power, while ensuring processing that is resistant to noise and to an abrupt change of trajectory. This technique is based on an approximation of the true distribution of the target's position (for example p(αₜ|y_{1 . . . t}) as detailed hereafter), which is difficult to estimate, by a simpler functional (for example q(αₜ) as detailed hereafter) while minimizing the approximation error (i.e. by seeking the approximate function that is closest to the true distribution, the difference between these distributions providing an estimation criterion).

This approximation allows temporal dependency to be limited to the functional of a single component (as detailed hereafter for the function q of the component μₜ which represents the distribution of the random mean used as a sufficient statistic in temporal terms). Thus, communication between 2 cameras assigned to update the distribution of filtering is limited to transmission of the parameters of a single Gaussian (the functional q(μₜ) which can then be limited to one mean and one covariance). Thus, the conventional approaches consisting of first updating the probability densities and to approximating them afterward is not necessary. The global collaborative tracking protocol is provided by the filtering algorithm (AF) and is based on the variational filtering described hereafter.

In certain particularly advantageous embodiments, an information criterion (relevance indicator or criterion J detailed later) is proposed in order to define the relevance of the processing carried out (i.e. the tracking of the target(s), that is the estimation of position over time) by a given camera. Based on this relevance criterion, a limited set of cameras is selected to implement the object tracking algorithm, thus further reducing power consumption. Certain embodiments take advantage of diverse uses of this relevance criterion.

In certain particularly advantageous embodiments, at every instant, the automatically activated cameras execute the tracking algorithm in a collaborative manner, by implementing the filtering algorithm in several cameras at the same time. Certain embodiments take advantage of this collaborative tracking by simultaneously implementing variational filtering in several cameras at a given instant, using sufficient statistics in temporal terms and sufficient statistics in spatial terms, allowing position to be made relative from one camera's position to another's. In a particularly advantageous manner, these sufficient statistics in spatial terms can be limited to the predicted position of the target estimated by at least one camera.

FIG. 1 illustrates an example of operation of an example network of wireless cameras for intrusion detection and the tracking of a moving person:
Period 1: detection/classification of the intrusion at the initial instant.
Period 2: tracking of the person by 3 cameras (S¹, S² and S³) in a collaborative manner.
Period 3: S¹ and S² automatically detect the non-relevance of their images; they broadcast the sufficient statistics and cameras S³, S⁴ and S⁵ auto-activate for cooperative tracking of the moving person.
Period 4: It is S⁴, S⁶ and S⁷ that take over the tracking of the person.

FIG. 1 also shows a magnification of a camera (S, in this case camera S² in FIG. 1) to highlight the resources (particularly S1, S2 and S21) that it includes.

Here variational filtering is mentioned because Bayesian filtering has always had the purpose of calculating the probability of an unknown (here, the position of the target) based on known data. Here, the variational filtering algorithm (AF) is based on a variational calculation in which one differentiates by a function because a criterion (estimation criterion corresponding to the difference between the real distribution of the target's position and the distribution estimated using the approximation function) is available that is dependent on a function (and not of a vector) and we seek the function (that is, the approximation functional) which allows the estimation criterion to be minimized.

The variational filtering algorithm (AF) is based on a variational filter providing an estimate (551) of the position of the target (X).

The inclusion of error models in the statistics exchanged in local processing at each node (each intelligent camera (S)) constitutes an attractive strategy for insuring effective and robust processing at the global, network level. From a methodological point of view, the variational approach allows implicit inclusion of the propagation of approximation errors by updating the approximated forms of the probability densities in a non-parametric setting. The principle of the variational method consists of exploring the entire state space, by approximating the probability density by simpler functionals (for example, the real probability density p(αₜ|y_{1 . . . t}) is approximated by q(αₜ) as detailed hereafter). Furthermore, the modeling of the hidden state dynamics by heavy-tailed densities allows detection and tracking of the monitored system in difficult cases such as a sudden change of trajectory for example. Indeed, the use of a simple Gaussian transition model in conventional system does not allow for the eventuality of a trajectory jump. On the other hand, the use of heavy-tailed densities allows for the occurrence of rare trajectory (T) change events, such as a rapid change of direction or of speed for example.

In particular, the state dynamics of the system Xₜ can be described by a model consisting of a continuous mixture of Gaussians (mean-scale mixture). According to this model, the hidden state xₜε [symbol] ⁿ^{ₓ} follows a Gaussian distribution with a random mean μₜ and a random precision matrix λₜ. The mean follows a Gaussian random walk expressing the temporal correlation of the trajectory of the hidden state of the system. The precision matrix follows a Wishart law:

$$\{ \begin{matrix}{μ}_{t} \sim 𝒩 ( {μ}_{t} \vert {μ}_{t - 1} , \overline{λ} ) \\ {λ}_{t} \sim {𝒲}_{\overline{n}} ( {λ}_{t} \vert \overline{𝒮} ) \\ {x}_{t} \sim 𝒩 ( {x}_{t} \vert {μ}_{t} , {λ}_{t} )\end{matrix} \qquad ( 1 )$$

where the hyperparameters λ̅, n̅| and S̅ are respectively the precision matrix of the random walk, the degree of freedom and the precision matrix of the Wishart distribution.

It will be noted that the expression (1) above corresponds to a model (MT) called a transition model, giving an a priori on the trajectory (T) of the target. It is worth noting that the random aspect of the mean and of the precision induces, a priori, a marginal distribution, the tail behavior of which can be adjusted in a simple manner according to the values of the hyperparameters. Moreover, a heavy-tailed distribution allows effective tracking of trajectories having sudden jumps because the mixture of Gaussians forms a probability density that is flexible enough not to exclude the possibility of a rare event.

The variational filter used in the present invention is therefore based on a transition model (MT) represented by a continuous mixture of Gaussians and giving a prior probability on the assumed trajectory of the target, by estimating the position of the target by a probability density. This continuous mixture of Gaussians is obtained in practice by defining an “augmented” or “extended” hidden state of the system (cf. αₜ=(xₜ, μₜ, λₜ) an example whereof is detailed hereafter), using a Gaussian distribution with a random mean μₜ and a random precision matrix λₜ. In particle filtering methods, a fixed value of the mean is determined based on the previous position of the target and a fixed value of the precision matrix is determined according to the displacement speed. As these values do not change during tracking by a particle filter, it is very probable that the estimate resulting from them is deficient, particularly in the case of a change of displacement speed of the target. conversely, in the present invention, the variational approach, by allowing joint estimation of the random mean (Gaussian distribution) and of the random precision matrix, allows these values to be updated during tracking. Indeed, a variational filter has a higher tolerance for an increase in the dimensions of a particle filter and therefore allows the introduction of such random variables to be estimated whereas a particle filter would diverge because it is not compatible with such an introduction.

The detection of a target can be defined as a classification problem. Thus, the detection algorithm (AD) defines a set of determined detection/classification parameters (or criteria), applied to the acquired images to define the target object, as is known in the prior art. Additionally, it is possible to apply a plurality of detection/classification algorithms and/or to apply the algorithm (or algorithms) to several detection areas within the acquired images. This detection comes down to defining a “reference descriptor” at the initial instant. Thereafter, at each subsequent instant, a likelihood function (for example p(yₜ|xₜ) as detailed hereafter), defined by the difference between the acquired data (images) and the reference descriptor, is used for variational filtering. Indeed, the relation between an image yₜ and the position of a target xₜ in that image is generally complicated and cannot be defined in advance. This relation is therefore expressed using a likelihood function which is used by the variational filtering implemented in the present invention. The likelihood is assumed to have a general form that is a function of the selected descriptor, used in the cameras for detecting the targets. A descriptor is a function for extracting characteristics from a signal, as for example a color histogram, an oriented gradient histogram or other more or less complicated functions known in the signal processing field. A descriptor is substantially equivalent to an observation model, that is in particular a likelihood function in the examples presented here. However, in the field of video “tracking,” the term descriptor is used because an observation model, properly so called, does not exist, the essential matter being the likelihood calculation. Here, for example, the descriptor can extract a feature from at least one rectangle of the image, containing the object to be tracked. The likelihood (for example p(yₜ|xₜ) as detailed hereafter) of any rectangle of the image at the current instant (t) can be defined as a decreasing function of the distance between the descriptor of that rectangle and the descriptor of the rectangle containing the object detected at the initial instant (also called the reference descriptor). For example, using the color histogram as a descriptor, the likelihood level of a candidate rectangle of the image at the current instant consists of calculating the exponential of the opposite of the Bhattacharya distance between the color histogram of that rectangle and that of the rectangle of the initial image containing the detected object.

Case 1: Only One Camera Activated at the Instant t

It is possible, depending for example on the configuration of the region (Z), that a single camera (S) is activated at the current instant (t) in order to implement the variational filtering. According to the transition model (MT), the “augmented” hidden state becomes αₜ=(xₜ, μₜ, λₜ) Instead of approximating the filtering distribution p(αₜy_{1 . . . t}) using a set of weighted particles as in the particle filtering known in the prior art, the principle of the on-line variational approach consists of approximating this distribution by another, simpler functional q(αₜ) while minimizing the Kullback-Leibler divergence with respect to the real filtering distribution:

$${D}_{KL} ( q \vert \vert p ) = \int q ( {α}_{t} ) log \frac{q ( {α}_{t} )}{p ( {α}_{t} \vert {y}_{1 , t} )} d ( {α}_{t} ) \qquad ( 2 )$$

By this minimization of the Kullback-Leibler divergence using the tools of variational calculation and by imposing a separable (non-parametric) form q(αₜ)=q(xₜ)q(μₜ)q(λₜ) the following iterative procedure is obtained:

$$\{ \begin{matrix}q ( {x}_{t} ) ∝ exp {〈 log p ( {y}_{1 … t} , {α}_{t} ) 〉}_{q ( {μ}_{t} ) q ( {λ}_{t} )} \\ q ( {μ}_{t} ) ∝ exp {〈 log p ( {y}_{1 … t} , {α}_{t} ) 〉}_{q ( {x}_{t} ) q ( {λ}_{τ} )} \\ q ( {λ}_{t} ) ∝ exp {〈 log p ( {y}_{1 … t} , {α}_{t} ) 〉}_{q ( {x}_{t} ) q ( {μ}_{t} )}\end{matrix} \qquad ( 3 )$$

Thus, the updating of the functional q(αₜ) is implemented iteratively. It is worth noting that the calculation of q(αₜ) is implemented sequentially (in time) based solely on knowledge of q(μₜ₋₁). Indeed, taking into account the separable form of the distribution at the previous instant (t−1), the filtering distribution is written:

$$\begin{matrix}p ( {α}_{t} \vert {y}_{1 , t} ) ∝ p ( {y}_{t} \vert {x}_{t} ) p ( {x}_{t} , {λ}_{t} \vert {μ}_{t} ) \int p ( {μ}_{t} \vert {μ}_{t - 1} ) q ( {α}_{t - 1} ) d {α}_{t - 1} \\ ∝ p ( {y}_{t} \vert {x}_{t} ) p ( {x}_{t} , {λ}_{t} \vert {μ}_{t} ) \int p ( {μ}_{t} \vert {μ}_{t - 1} ) q ( {μ}_{t - 1} ) d {μ}_{t - 1}\end{matrix} \qquad ( 4 )$$

where only integration with respect to μₜ₋₁ is employed due to the separable form of q(αₜ₋₁). Here our basis is the temporal correlation (auto-correlation) of the trajectory using the probability of the target's position at the previous instant. The temporal dependence is therefore limited in the present invention to the functional of a single component (q(μₜ₋₁) representing the distribution of the random mean). Indeed, the updating of the approximating functional q(αₜ) is implemented sequentially by taking into account only the previous distribution q(μₜ) of the random mean. It will be noted here that the likelihood p(yₜ|xₜ) reappears in the expression of the filtering distribution.

In a decentralized context, communication between 2 units (i.e., “intelligent cameras” or “nodes” assigned to update the filtering distribution is limited to the transmission of q(μₜ₋₁) which thus represents the sufficient statistic in temporal terms. This q(μₜ₋₁) which corresponds to the distribution of the random mean of the position of the target (X) at the previous instant, represents the knowledge of the trajectory at the previous instant. At each current instant (t), during the updating of the variational filter, this temporal statistic is recalculated and then represents the knowledge of the trajectory at the current instant (t), for use in the following instant (t+1) to continue tracking. It will be noted that in the case of particle filtering, this knowledge requires a plurality of particles (and therefore a considerable quantity of data). In addition, a simple calculation makes it possible to show that this functional is a Gaussian and therefore that communication between two successive “leader nodes” (=intelligent cameras active from a previous instant (t−1) to the given instant (t), or equivalently from a given instant (t) to the following instant (t+1)) amounts to sending a mean and a covariance. Thus, the conventional particle approach consisting of first updating the probability densities and later approximating them is no longer necessary. This joint processing of the data and the approximation of sufficient statistics is particularly advantageous in terms of effectiveness and of speed, but also in terms of power consumption, as transmitting a mean and a covariance between intelligent cameras is sufficient.

Case 2: Several Cameras Activated at the Instant t

In certain embodiments, estimation can be implemented collaboratively by several cameras that are active at the same time, thanks to a dependency between their respective variational filters expressed by a dynamic homography model connecting the random means of the position of the target (X) respectively estimated by each of the active cameras.

In the previous case (1 camera only), the collaborative aspect manifests itself in the temporal dimension (changing of cameras and passing of sufficient statistics between two successive instants). In the present case (several cameras activated simultaneously), a naive solution would consist of selecting a single camera (leader camera) which receives all the images sent by the other cameras and which implements exactly the variational filtering described above. However, this solution results in too high a power consumption for transmitting images. In certain embodiments, variational filtering distributed among several cameras is proposed instead, without having the cameras send their images over the network. In various embodiments of the invention, the cameras transmit only sufficient statistics to one another. In the case of a single active camera at a current instant, these sufficient statistics relate only to the temporal dimension. In the case where several cameras are active at the same time (performing tracking), these sufficient statistics relate to the temporal dimension and to the spatial dimension, but the cameras do not need to exchange any data beyond these statistics, which are thus designated as being sufficient (for tracking the target). The principle of this collaboration is based on a dynamic graph model wherein the target has states (positions) in each of the cameras.

In order to illustrate this collaboration in a simple manner, let us take the case of 2 cameras S¹ and S². The target has a position xₜ¹ in the image yₜ¹ emanating from the first camera S¹ and a position xₜ² in the image yₜ² emanating from the second camera S². Between the two cameras, a homography transformation H makes it possible to transform xₜ¹ into xₜ².

The dynamic model proposed is the following:

$$\{ \begin{matrix}{μ}_{t}^{1} \sim 𝒩 ( {μ}_{t}^{1} \vert {μ}_{t - 1}^{1} , \overline{λ} ) \\ {λ}_{t}^{1} \sim {𝒲}_{\overline{n}} ( {λ}_{t}^{1} \vert \overline{S} ) \\ {x}_{t}^{1} \sim 𝒩 ( {x}_{t}^{1} \vert {μ}_{t}^{1} , {λ}_{t}^{1} )\end{matrix} \\ \{ \begin{matrix}{μ}_{t}^{2} \sim 𝒩 ( {μ}_{t}^{2} \vert {μ}_{t - 1}^{2} , \overline{λ} ) \\ {λ}_{t}^{2} \sim {𝒲}_{\overline{n}} ( {λ}_{t}^{2} \vert \overline{S} ) \\ {x}_{t}^{2} \sim 𝒩 ( {x}_{t}^{2} \vert {μ}_{t}^{2} , {λ}_{t}^{2} )\end{matrix} \\ {μ}_{t}^{2} \sim 𝒩 ( {μ}_{t}^{2} \vert {ℋμ}_{t}^{1} , \sum ) \qquad ( 5 )$$

Where the dependency between the two variational filters is expressed through the homography model (μₜ²˜ [symbol] (μₜ² [symbol] μₜ¹, Σ)).

This homography model links the random means of the target in the 2 images emanating from the 2 cameras.

The dynamic model can for example be represented as illustrated in FIG. 3.

The modeling of the relation between the images of the same target using only the homographic transformation H between the means makes it possible to implement a parallel variational filter without the necessity of exchanging complete images yₜ¹ and yₜ² between cameras. In fact, let us consider the augmented state (αₜ¹,αₜ²); the variational filter proposed consists of approximating p(αₜ¹,αₜ²|y_{2 . . . t}) by the separable functional q(xₜ¹)q(λₜ¹)q(xₜ²)q(μₜ²,μₜ²) while minimizing their Kullback-Leibler divergence, similar to the approach using a single camera, but here, each camera collaborating at a given instant can take into account the processing carried out by at least one other camera. An iterative procedure is then obtained, similar to that implemented in the case of a single camera.

Updating the Variational Filter

Following the position prediction step allowing the determination (552) of sufficient statistics in temporal terms, the filter updates the position estimate. The likelihood function p(yₜ|xₜ) reappears in this update of the variational filter.

Again, the case where a single camera is active is distinguished from the case where several cameras are active (2 in the example below).

Case of a Single Filter (Only 1 Active Camera)

By substituting the filtering distribution of equation (4) above into equation (3) above, and taking into account the a priori transition model (MT), defined in equation (1), the update of the separable distribution q(αₜ) has the following form:

q(xₜ)∝p(yₜ|xₜ) [symbol] (xₜ| [symbol] μₜ [symbol] , [symbol] λₜ [symbol] )

q(μₜ)∝ [symbol] (μₜ|μₜ*,λₜ*)

q(λₜ)∝ [symbol] _{n*}(λₜ|Sₜ*)

where the parameters are calculated iteratively according to the following scheme:

μₜ*=λₜ*⁻¹( [symbol] λₜ [symbol] [symbol] xₜ [symbol] +λₜ^{p}μₜ^{p})

λₜ*= [symbol] λₜ [symbol] +λₜ^{p}

n*= n̅+1

Sₜ*=( [symbol] xₜxₜ^{T})− [symbol] xₜ [symbol] [symbol] μₜ [symbol] ^{T}−(μₜ) [symbol] xₜ [symbol] ^{T}+ [symbol] μₜμₜ^{T} [symbol] + S̅⁻¹)⁻¹

μₜ^{p}=μₜ₋₁*

λₜ^{p}=(λₜ₋₁*⁻¹+ λ̅⁻¹)⁻¹ (6)

It can be noted that the mean μₜ and the precision matrix λₜ have known distributions having simple likelihood factors:

[symbol]

μₜ [symbol] =μₜ*, [symbol] λₜ [symbol] =n*Sₜ*, [symbol] μₜμₜ^{T} [symbol] =λₜ*⁻¹+μₜ*μₜ*^{T}

However, the distribution of the component xₜ does not have a simple explicit form. In order to calculate its likelihood factor and its covariance, the technique of importance sampling (Monte Carlo) is called upon where samples are simulated according to the Gaussian [symbol] (xₜ| [symbol] μₜ [symbol] , [symbol] λₜ [symbol] ) and then weighted according to their likelihood factors:

x⁽ⁱ⁾˜ [symbol] (xₜ| [symbol] μₜ [symbol] , [symbol] λₜ [symbol] ),wₜ⁽ⁱ⁾∝p(yₜ|xₜ⁽ⁱ⁾) (7)

The mean and the covariance are then simply obtained by empirical means:

$$( {x}_{t} ) = {\sum }_{i = 1}^{N} {w}_{t}^{( i )} {x}_{t}^{( i )} , ( {x}_{t} {x}_{t}^{T} ) = {\sum }_{i = 1}^{N} {w}_{t}^{( i )} {x}_{t}^{( i )} {x}_{t}^{( i ) T}$$

Let us note that, unlike the distributed particle filter, the Monte Carlo sampling procedure above remains local at the camera level.

Case of Several Filters (Several Active Cameras)

Taking the dynamic model (5) as a basis (2-camera case to simplify the presentation), the variational calculation is carried out in the same way as before.

The separable probability distributions of (αₜ¹,αₜ²) have the following form:

q(xₜ¹)∝p(yₜ¹|xₜ¹) [symbol] (xₜ¹| [symbol] μₜ¹ [symbol] , [symbol] λₜ¹ [symbol] )

q(xₜ²)∝p(yₜ²|xₜ²) [symbol] (xₜ²| [symbol] μₜ² [symbol] , [symbol] λₜ² [symbol] )

q(λₜ¹)∝ [symbol] _{n*}(λₜ|Sₜ¹)

q(λₜ²)∝ [symbol] _{n*}(λₜ|Sₜ²)

q(μₜ¹,μₜ²)∝ [symbol] (μₜ¹,μₜ²|mₜ*,Σₜⁿ) (8)

Where the calculation of the parameters of the laws of (λₜ¹, λₜ², μₜ¹, μₜ²) requires only knowledge of the statistics [symbol] xₜ¹ [symbol] , [symbol] xₜ¹xₜ¹^{^{T}} [symbol] , [symbol] xₜ² [symbol] and [symbol] xₜ²^{^{T}} [symbol] which are calculated locally in each camera and constitute sufficient statistics in spatial terms for the cameras collaboratively implementing the variational filter. It will be noted here that the likelihood level p(yₜ|xₜ) reappears in the expression of the filtering distributions.

At least 2 cameras in the network will then be able to exchange data (SS) representative of sufficient statistics in spatial terms [symbol] xₜ^{S}^{ⁿ} [symbol] , [symbol] xₜ^{S}^{ⁿ}xₜ^{S}^{^{nT}} [symbol] , in addition to those in temporal terms described previously (in the case of 2 cameras, these data are expressed in the above form [symbol] xₜ¹ [symbol] , [symbol] ₜ¹xₜ¹^{^{T}} [symbol] , [symbol] xₜ² [symbol] and [symbol] ₜ²xₜ²^{^{T}} [symbol] of spatial statistics). The data (SS) representative of sufficient statistics will then be able, depending on the case and over time, to include data representative at least of the temporal statistics such as those mentioned previously which represent the distribution of the random mean q(μₜ₋₁) of the estimated position of the target (X), and when several cameras (Sⁿ) are active at the same time and implementing the variational filter, data representative of spatial statistics such as [symbol] xₜ^{S}^{ⁿ} [symbol] , [symbol] xₜ^{S}^{ⁿ}xₜ^{S}^{^{nT}} [symbol] . It will be noted that the temporal statistics represent the distribution of the random mean at the previous instant (t−1) while the spatial statistics represent the likelihood factors of the positions of the target (X) in the image of each camera that is active at the current instant (t). For the temporal statistics as for the spatial statistics, the dependence (temporal and spatial, respectively) relates to the random mean of the target's position.

Determination of a Relevance Indicator (J), Selection of the Active Cameras:

As mentioned previously, in certain embodiments the cameras calculate a relevance indicator (J), defined in a selection algorithm (AS) for selecting the active cameras which must carry out the tracking (to continue it or give it up, from the current instant to the following instant). This selection must be based on a criterion allowing the evaluation and comparison of the relevance of the images acquired by the camera with respect to the tracking objective. The underlying principle is that if one is able to predict the position without the data (image) from the camera at the current instant, then it is not relevant and is therefore not necessary for tracking. It is therefore proposed to use an information criterion measuring the distance (difference) between the predicted probability density (that is the probability of the estimated position xₜ at the current instant t, knowing the data up to the previous instant t−1) and the updated probability density taking into account the data (images) acquired at the current instant (that is to say the probability of the estimated position xₜ knowing the data up to the current instant t). This relevance indicator therefore represents the difference (distance or divergence) between the probability density of the target's position obtained by variational filtering in the previous instant and the probability density of the target's position updated at the current instant.

In certain particularly advantageous embodiments, this relevance indicator (J) can be calculated using results arising from variational filtering. This distance (or difference) is measured by the Kullback-Leibler divergence. The following criterion is thus obtained:

[symbol]

(c₁)= [symbol] ₕₗ(p(xₜ|y_{1;t})∥p_{prod}(xₜ|y_{1;t-1})) (9)

This calculation (9) of the relevance criterion (J), involving inextricable integrals, is normally based on particle filtering. In the present invention, thanks to the use of variational filtering, one simplification consists of calculating the criterion at the current instant and taking the variational approximation as a basis. A simple variational calculation shows that the predictive distribution p_{pred}(xₜ|y_{1;t-1}) can be approximated by a Gaussian:

p_{pred}(xₜ|y_{1;t-1})≈ [symbol] (xₜ;μ_{pred},λ_{pred})

The criterion (J) calculated in (9) can thus be simply approximated by the following expression:

$$\begin{matrix}𝒥 ( {c}_{i} ) \approx {𝒟}_{hl} ( q ( {x}_{t} ) \vert \vert {q}_{pred} ( {x}_{t} ) ) \\ \approx {\sum }_{j = 1}^{n} {w}_{t}^{( i )} log q ( {x}_{t}^{( i )} ) / {q}_{pred} ( {x}_{t}^{( i )} )\end{matrix} \qquad ( 10 )$$

where the samples xₜ⁽ⁱ⁾ and their weights wₜ^{(l)} were already obtained during the implementation of variational filtering.

It is therefore understandable that, in calculating the relevance indicator (J), the calculation of the true distributions p and p_{pred} is replaced by their variational approximation q and q_{pred} obtained using variational filtering.

The criterion (J) represents the informational contribution of the images acquired by the camera. In fact, the distance between the predicted density (not taking into account the image at the instant t) and the updated density (taking into account the image at the instant t) measures the contribution of the acquired image. If this distance is small, then the data from the camera are not useful in tracking the target and the camera is therefore not relevant. The same criterion (J) can also be used for classifying cameras according to their relevance and thus perform a competition process (52) for selecting only cameras able to provide relevant information for tracking in certain embodiments.

The person skilled in the art will understand from reading the present application that the various embodiments detailed in the present description can be mutually combined. Conversely, the technical features detailed in the various embodiments presented by way of indication in the present application can generally be isolated from the other features of these embodiments so long as the variational filter is implemented, unless the contrary is expressly stated or it is obvious that such an isolation of a feature would not allow solution of the target tracking problem. Indeed, the variational filtering described here allows a relevance indicator (J) to be used or not, the network can or cannot comprise several cameras and the variational filtering implemented can utilize only one camera at a time or can use several cameras at the same time.

Several functional aspects described in the present description are designated as being supported by “processing resources” using algorithms. It is understood, particularly upon reading the present application, that the components of the present invention, as generally described and illustrated in the figures, can be arranged and designed according to a great variety of different configurations. Thus, the description of the present invention and the pertinent figures are not intended to limit the scope of the invention, but represent only selected embodiments. For example, the processing resources can include computer resources and/or at least one electronic circuit, such as an integrated circuit for example and/or other types of arrangements and components, such as for example semiconductors, logic gates, transistors, one or more processor(s) or other discrete components. Such processing resources can also support one or more software application(s) or pieces of executable code within a software environment for implementing functionalities described here. The functionalities are described with reference to algorithms to illustrate that processing resources will employ functional arrangements which correspond to processing algorithms, which can in fact be implemented for example in the form of executable code instructions. For example, the sensors can include memory resources storing at least data representative of the algorithms but it is obvious that, as the sensors can be provided with communication resources, the set of data needed for the implementation of the invention need not necessarily be stored in the sensors and may be present only in volatile form and that the processing resources can use data representative of algorithms or of processing results based on those algorithms, coming from an outside source, even though the present invention actually makes it possible not to require this type of arrangement since it reduces the necessary computing power and the costs in terms of data processing and communication, which makes it particularly suited to networks of isolated sensors with energy resources that are limited and nonrenewable or poorly renewable. It is therefore understood that the invention is preferably implemented in the form of intelligent cameras including embedded electronics for carrying out calculations and that they do not require a central system because they form an autonomous network. However, it is not necessary for this autonomous network to be completely independent from a central system. Certain embodiments will provide communication with at least one centralization device, as detailed hereafter.

In addition, one or more physical or logical block(s) of machine instructions can, for example, be organized into an object, process or function. Moreover, the routines and instructions used by these processing resources do not need to be physically co-located, but may comprise disparate instructions stored in different places which, once assembled functionally and logically, form the algorithm implemented by processing resources as described here, to carry out the functions indicated for the algorithm. A single executable code instruction, or a plurality of instructions, can in fact be distributed among several different segments of code or among different programs and stored in several blocks of memory. Likewise, operational data can be identified and illustrated in processing resources, and can be incorporated into any appropriate form of data structure. Operational data can be collected or can be distributed over different location including different finite storage devices and can exist, at least partially, simply as electronic signals on a system or a network. The device is here sometimes designated as comprising processing resources in certain embodiments, but the person skilled in the art will understand that it can in fact be associated with such resources or include them in its structure, even though it is more advantageous in the present case that it include them in its structure since the processing that it carries out makes it possible to minimize the quantity of data which much travel over the communication resources. The device includes data processing resources making it possible to carry out the functions described and can therefore include (or be associated with) specific circuits carrying out these functions or include (or be associated with), in a general sense, computer resources allowing the execution of instructions fulfilling the functions described in the present application. The person skilled in the art will understand the numerous variations of implementation are possible in addition to the variations in the autonomous network of cameras with embedded electronics allowing the performance of all the functions described in the present application which are most advantageous for a plurality of reasons already mentioned.

The invention can advantageously be implemented in a network of cameras having limited resources and hence limited production costs, thanks to the speed and simplification permitted by the algorithms described here. As mentioned previously, the network of intelligent cameras according to the invention is called autonomous because in the preferred embodiments, these cameras have embedded in them processing and communication resources in addition to image acquisition resources and cooperate in complete autonomy for carrying out tracking. Furthermore, power supply can be included in these cameras (such as batteries for example) so as to avoid supplying them from an electrical power network. However, it will be understood that each of the cameras in the network can communicate with at least one device, called a centralization device, which can centralize at least part of the data that are processed. For example, such a device (or system) can consist of or include at least one terminal including communication resources and memory, and possibly data processing resources. This terminal can for example be portable (such a portable computer or any kind of terminal, even with more limited computing power such as a “PDA,” a “smartphone” or a dedicated terminal). Thus, the cameras will be able to send to this centralization device at least part of the data that they have processed (image data, data regarding tracking, etc. . . . ) for archiving in the memory resources of this centralization device. Likewise, the centralization device can include at least one terminal allowing an operator to follow the result of the processing carried out by the network of cameras or to follow at least part of the images acquired, selected for example during tracking. For example, a display of the trajectory and/or of the cameras activated over time and/or at least one image acquired (for example by a camera selected on the basis of its location with respect to the target, as explained hereafter) can be performed on such a terminal. Likewise, the network can have been configured to transmit an alert to an appropriate office (security, police, etc.) and the centralization device can then simply include resources for warning the persons concerned by the alert. In another example, the centralization device includes processing resources allowing processing of data received from the camera network and to manage various displays to be presented to an operator on a display device. A graphic user interface and data entry resources (input resources such as keyboard, mouse, touch-screen, etc.) of the centralization device will allow the operator to interact with the device and to check for example the data which the cameras in the network are sending to the centralization device. Thus a display, for example in real time, allows the operator to check and to confirm the alert, for example via a portable terminal, for example by transmitting the alert to the persons concerned. For example, a target is tracked by the network and the operator receives at least one image from at least one of the cameras showing him the target. In one variation, the operator then has the option of validating at least one image, for example to have it stored in the memory resources of the centralization device. In other variations, the camera network will be configured so that at least one of the cameras that is relevant during tracking retains, it the embedded memory resources (for example in flash memory, requiring very little power), at least one image of the target that is tracked. As a variation, this or these image(s) will be stored in the centralization device (or system or terminal). In certain embodiments, whether or not the network is associated with a centralization device, the network of intelligent cameras can be configured for taking images of the target by at least one of the cameras performing tracking at a given instant, on the basis of the estimated trajectory (T) of the target (described previously). Thus for example, thanks to knowledge of the estimated coordinates and/or trajectory of the target, the network of cameras with known geographic locations can decide which is (are) best situated to take an image of the target (one photo or a video, of short duration for example). In one variation, the coordinates and/or the trajectory can also be used for selecting at least one effective area in which a target is located within the entire view captured by the selected camera(s) for the imaging task. The data to be stored and/or transmitted are thus minimized while still guaranteeing that the target is present and without degrading the image quality. To minimize still further, the resolution can also be reduced by the camera. In one variation, the imaging taken can be transmitted to a centralization device for display to an operator who confirms the storage of the image, for example according to its relevance (for example to avoid storing images of animals having entered the monitored location and which might have triggered tracking and imaging).

The present application refers to “a known geographic location” of the cameras. The person skilled in the art will understand upon reading the present application that the location of the cameras is considered to be fixed because the cameras send one another information concerning the target but not the positions of the cameras themselves. In fact, here the expression “known geographic location” designates the fact that the cameras know the respective positions of their “fields of vision.” The cameras used have a fixed position, and preferably a fixed “field of vision” (meaning that the geographic area covered by a camera does not vary over the course of time). In fact, a given camera only sends information on the position of the target within its own field of vision, used with advantage by other cameras for finding the target in their field of vision according to certain embodiments. In fact, the exact position of the cameras is not useful information but information defining whether two cameras have fields of vision (i.e. covered geographic areas) that overlap at least partially or corresponding to areas neighboring or remote from a site (a monitored area (Z)) is used in various embodiments of the invention. Thus, when the invention comprises a network of cameras, the latter have a “known geographic location” in the sense that each known whether a neighboring camera shares part of its field of vision or whether the field of vision of a neighboring camera is located near its own or is remote. In the embodiments where a single camera covers the monitored area (Z) (cf. hereafter), this “known geographic location” is not necessary.

Moreover, when at least two cameras have fields of vision that overlap at least partially (i.e. the geographic areas covered by at least two cameras have at least one portion in common), the invention advantageously uses a homographic transformation of the position of the target between cameras. Thus, thanks to this homography, one camera is capable of finding the position of the target in its field of vision based on information relating to a position of the target in the field of another camera that transmits this information to it. The invention does not require that this homographic transformation be very precise/accurate because the use of probabilistic data makes relative in precision/accuracy tolerable. Moreover, the invention can make it possible, even in the case where two cameras have overlapping fields, for a camera that loses the target (i.e. whose target leaves the field of vision) to send an alert to other cameras for them to attempt to detect the target. In the cases where two cameras have fields of vision that do not overlap but are neighboring, the alert sent by the camera losing the target can be addressed only to the camera(s) into whose field the target is likely to enter. Likewise, in the case of cameras whose fields overlap at least partially, this alert can be limited to those cameras whose field of vision overlaps at least partially that departed by the target (i.e. that of the camera broadcasting the alert) and can be accompanied by information relating to the position of the target within the field of the camera whose target is leaving the field of vision, which will allow another camera, thanks to the homography transformation, to find the position of the target in that part of its field of vision which overlaps that of the camera which transmitted the information to it. Thus, this alert mechanism allows the cameras, firstly, to attempt to detect the target, then resume tracking as described in the present application, and secondly to calculate the position of the target in their fields based on the position in the field of a neighboring camera, when their respective fields of vision overlap at least partly. It is also understood that this alert mechanism even allows for the known geographic location not to be necessary. Indeed, in certain embodiments, a camera that loses the target systematically sends an alert to the other cameras so that they detect the target and continue tracking. Thus, whatever the respective positions of the cameras (and of their fields of vision in particular), the invention can still be implemented effectively at least for individual tracking. However, for collaborative tracking, the homographic transformation itself already defines the fact that the geographic locations are known (in the sense used here; that is by the fact that the cameras know any correspondences that might occur between their fields of vision).

In practice, the homography transformation between two cameras can be defined in advance thanks to the establishment of a correspondence of at least two points in at least one common portion of their fields of vision. Thus, during deployment of the network of intelligent cameras, data representing the correspondence between their fields of vision is recorded in said cameras. The dynamic homography model H connecting the random resources of the position of the target (X) respectively estimated by each of the active cameras, described in the present application, can therefore be used by the cameras for finding the correspondence in the position of the target in their respective images. In cases where a single camera is performing the tracking at a given instant but the network comprises several cameras, the homography model H (as detailed in the present application) allows a second camera to find the target in its field of vision based solely on the sufficient statistics in temporal terms provided by a first camera.

Thus, according to various embodiments, the cameras have known geographic locations thanks to the fact that their processing resources (S1) use data representative of the relative positions of their respective fields of vision. For example, the cameras have known geographic locations in that they store data representative of information defining the relative positions of their respective fields of vision (for example by information such as “at least partially common fields” and/or “remote fields”). The present application details algorithms for individual tracking of a target (one camera at a time) and for collaborative tracking (several cameras). It will be noted that in the case where at least two cameras have at least partially overlapping fields, the network can nevertheless be configured so that a single camera at a time performs individual tracking. In this case, instead of having the two cameras with overlapping fields carry out collaborative tracking at the same time when the target is in the common portion of their fields of vision, a single camera (for example that whose field of vision the target entered first) carries out tracking and when it loses the target, it sends information on the estimated position of the target to the neighbor which, knowing that its field of vision overlaps with that which is sending it the information and knowing the homographic transformation to be carried out based on the position transmitted to it, can calculate the position of the target within its own field of vision for continuing the tracking. It is therefore understood that the homography transformations described in the present application can be advantageously used for collaborative tracking by several cameras, but also for successive individual tracking by several cameras.

It is understood from the foregoing that the network of cameras according to the invention makes possible numerous known uses in the field of surveillance (alerting an office, sending an image) but also allows numerous functionalities that are particularly advantageous compared with conventional surveillance systems. In particular, the invention allows images to be taken which can be stored but allows the number of them to be limited, if desired, and to limit the quantity of data traveling through the network during tracking, and even while images of the monitored target are being taken (by selecting at least one camera that is optimally situated and/or by selecting an effective area for image taking, etc.).

It is also understood upon reading the present application that the invention can therefore relate to at least one intelligent camera covering at least one geographic area, comprising data processing resources, image acquisition resources and communication resources, characterized in that the data processing resources implement at least one target location algorithm by implementing the invention, in particular by the variational filtering described in the present application. Such an intelligent camera is preferably intended to be used in collaboration with other cameras of the same type, so as to form a network as previously described covering a predetermined area. However, in certain embodiments, such an intelligent camera can be used in isolation (this is then not really a network since there is only one camera and the area that it covers then simply corresponds to the field covered by its acquisition resources) and not include communication resources (it will then use the temporal sufficient statistic that it will have calculated itself for continuing tracking at the current instant). Further, such an isolated camera does not need to know its location. In certain embodiments, such an isolated intelligent camera can include communication resources for transmitting data to a central terminal as described previously. Such an isolated communicating camera also does not require knowledge of its location.

Finally, the equations detailed here are a form of expression particularly suited to the implementation of the invention, but the person skilled in the art will understand possible adaptations of the mathematical formulation to obtain the same functions and advantages as those described here for algorithms. In particularly advantageous fashion, the mathematical expressions provided here allow the algorithms (particularly thanks to the simplifications and approximations achieved) to be executed very quickly while requiring few (computation, hence energy) resources. In certain embodiments, the algorithms implemented (implemented within the network of cameras and/or for implementing the method) will therefore be based on the calculations and equations detailed here which are particularly suited to the goals of limiting the computation and energy resources of the intelligent cameras in the network (and/or the communication capacities of the communication resources).

Generally, the various embodiments, variations and examples described here, particularly for particular technical features of the invention, can be mutually combined unless the contrary is expressly stated in the present application or they are incompatible or the combination will not work. Moreover, it must be clear to persons versed in the art that the present invention allows embodiments in numerous other specific forms without departing from the field of application of the invention as claimed. Consequently, the present embodiments must be considered to be by way of illustration, but can be modified within the field defined by the scope of the appended claims, and the invention must not be limited to the details given above.

1. A method for tracking at least one target using a network of intelligent cameras, each comprising data processing resources implementing at least one algorithm for tracking a target or targets, image acquisition resources and communication resources, the network of cameras covering at least one geographic area, called the region, comprising detection of at least one target in the region, by at least one camera in the network, based on execution of at least one detection algorithm, followed by, for each instant (t), an iteration of at least one tracking operation of the target by at least one camera, called the active camera, thanks to at least one variational filtering algorithm based on a variational filter, using a likelihood function for the position of the target in the image acquired by said active camera and using a model, called a transition model, represented by a continuous mixture of Gaussians and based on a temporal correlation of a trajectory of the target from one instant to another, by implementing estimation of the position of the target by a probability density.

2. A method according to claim 1, wherein the tracking operation at a given instant (t), further comprises a determination of data representative of a sufficient statistic in temporal terms, representing knowledge of the trajectory, for continuing the tracking of the target in the following instant (t+1).

3. A method according to claim 1, wherein the tracking operation at a given instant (t), further comprises a determination of a relevance indicator of the estimate of the position of the target, based on execution of at least one selection algorithm allowing the selection of at least one active camera for performing tracking, according on its relevance indicator which represents the difference between the probability density of the target's position predicted in the previous instant and the probability density of the target's position estimated in the current instant.

4. A method according to claim 3, wherein the detection of at least one target present in the region at an initial instant, triggers the tracking of the target by all cameras having detected the target, followed by a competition between the cameras according to the determined relevance indicator, for selecting the most relevant and assembling a set of cameras, called active cameras, assigned to tracking at the given instant (t).

5. A method according to claim 3, wherein the determination of a relevance indicator of the processing performed triggers a comparison for each camera active at a given instant (t), of the relevance indicator with a threshold determined in the selection algorithm allowing the camera, depending on the result of the comparison, to continue tracking or to stop tracking.

6. A method according to claim 5, wherein the comparison for each camera active at a given instant (t), of its relevance indicator with a threshold is accompanied by a comparison of the change in the relevance indicators of the other cameras, to take that change into account in deciding between continuing tracking and giving it up stopping tracking, and deciding whether to transmit to other cameras in the network its data representative of the sufficient statistic determined by that camera, this transmission triggering the reiteration of the competition between the cameras for assembling a new set when the relevance indicator of all the cameras crosses the threshold.

7. A method according to claim 1, characterized in that the tracking operation comprises, at each instant (t), an iteration of a prediction of the position(s) of the target(s) in the following instant.

8. A method according to claim 1, wherein the data (SS) representative of sufficient statistics in temporal terms are representative of a mean and a covariance of the random mean of the estimated position of the target.

9. A method according to claim 1, wherein the cameras have known geographic locations based on the processing resources use of data representative of the relative positioning of their respective fields of vision.

10. A method according to claim 9, wherein the tracking step, using variational filtering, at the instant (t), when several cameras are activated, is implemented in a collaborative manner by the active cameras, based on a dependence between their respective variational filters expressed by a dynamic homography model connection the random resources of the position of the target estimated respectively by each of the active cameras.

11. A method according to claim 10, wherein tracking is performed collaboratively by the active cameras by exchanging data representative of sufficient statistics in spatial terms between cameras, in addition to those in temporal terms, these sufficient statistics in spatial terms representing the likelihood factors of the positions of the target in the image of each camera active at the current instant (t).

12. A system for tracking at least one target by a network of intelligent cameras, each comprising data processing resources, image acquisition resources and communication resources, the network of cameras covering at least one geographic area, called the region, wherein the data processing resources implement at least one algorithm for locating and tracking target(s) by implementing the method according to claim 1.

13. A system according to claim 12, wherein at least one algorithm used is based on a variational filter allowing the data exchanged between the cameras for tracking to be limited to one mean and one covariance.

14. A system according to claim 12, wherein at least one image is able to be acquired during tracking by at least one of the cameras, selected according to its position with respect to the coordinates and/or to the trajectory of the target.

15. A system according to claim 14, wherein said image, acquired by at least one camera selected for its position, is stored in the memory resources of the same camera.

16. A system according to 12, further comprising at least one centralization device comprising memory means and/or display resources for, respectively, storage and/or display of data relating to tracking and/or to said acquired image, transmitted by the cameras.

17. A system according to claim 16, wherein the centralization device further comprises input resources allowing an operator to check tracking of the target based on data transmitted by the cameras and displayed on said device and, if applicable, to alert a cognizant office via the communication resources of said device.

18. An intelligent camera, covering at least one geographic area and comprising data processing resources, image acquisition resources, wherein the data processing resources implement at least one algorithm for locating a target or targets by implementing the method according to claim 1.

19. An intelligent camera according to the foregoing claim, further comprising communication resources for communicating with another intelligent camera for implementing the method according to claim 1.

20. An intelligent camera according to 18, further comprising communication resources for communicating with a centralization device comprising resources of communicating with at least one camera and memory resources and/or display resources for respectively storing and/or displaying data relating to tracking and/or to said acquired image.
